(19) United States
(12) Patent Application Publication
(10) Pub. No.: US 2011/0177383 A1
(43) Pub. Date: Jul. 21, 2011

(54) Battery cell module for modular battery with interleaving separator

(75) Inventors: Duncan Culver, Howell, NJ (US); Christopher K. Dyer, Madison, NJ (US); Michael L. Epstein, Bedminster, NJ (US)

(73) Assignee: Lightening Energy, Dover, NJ (US)

(21) Appl. No.: 12/657,310

(22) Filed: Jan. 19, 2010

(51) Int. Cl. H01M 2/24; H01M 4/02

(52) U.S. Cl. 429/160; 429/211; 29/623.1

(57) ABSTRACT

A cell module for a modular battery includes a plurality of positive electrode plates having positive connections extending from the positive electrode plates and having a first end and an opposite second end; a plurality of negative electrode plate having negative connections extending from the negative electrode plates and having a third end and an opposite fourth end, the positive and negative electrode plates alternating and being stacked so that the first and third ends are on a same side of the cell module and the second and fourth ends are on an opposite side; and a separator between the positive and negative electrode plates and covering the second end and the third end. A modular battery and a method are also provided.

### BACKGROUND

Modular batteries are batteries which comprise two or more battery cells or cell modules or cells. A common example of a device using a modular battery is a hand held flashlight which may use for example two C cells. Recently, modular batteries have become important in many applications, including hybrid electric vehicles (“HEV”), plug-in hybrid electric vehicles (“PHEV”), and other applications. When used in HEV, PHEV, and other applications, in addition to being durable, safe and cost effective, modular batteries are required to deliver a great deal of power.

Applications of modular batteries, like the hand-held flashlight, require the use of multiple battery cells connected in series. However, the modular batteries for HEVs and PHEVs, for example, may differ from the modular C cells used in a common flashlight.

U.S. Patent Publication No. 2009-0239130 A1 discloses a modular battery with battery cell modules, and is hereby incorporated by reference herein.

### SUMMARY OF THE INVENTION

The present invention provides a cell module for a modular battery comprising: a plurality of positive electrode plates having positive connections extending from the positive electrode plates and having a first end and an opposite second end; a plurality of negative electrode plates having negative connections extending from the negative electrode plates and having a third end and an opposite fourth end, the positive and negative electrode plates alternating and being stacked so that the first and third ends are on a same side of the cell module and the second and fourth ends are on an opposite side; and a separator between the positive and negative electrode plates and covering the second end and the third end.

A modular battery with a plurality of the cell modules is also provided.

The present invention also provides a method for forming a cell module for a modular battery comprising: interleaving a single piece of separator between a plurality of positive electrode plates and a plurality of negative electrode plates to eliminate direct electrical contact between the positive and negative electrode plates.

### BRIEF DESCRIPTION OF THE DRAWINGS

The present invention will be described with respect to a preferred embodiment, in which:

FIG. 1 schematically shows in cross-section a modular cell according to one embodiment the present invention;

FIG. 2 schematically shows in cross-section an alternate embodiment of the present invention.

The drawings are schematic in nature and not to scale. For clarity and ease of understanding, some elements have been exaggerated in size.

### DETAILED DESCRIPTION

In order to be powerful enough for HEVs, PHEVs, and other applications, it is desirable to use modular batteries containing cells with a high surface to volume ratio, for example using a planar design for each cell of the battery. These cells may be, for example, about the size of a large book wherein the “front” of the book contains, for example, a positive terminal (also known as an electrode) and the “back” of the book contains, for example, a negative terminal. Unlike their cylindrical counterparts (e.g., C cell batteries) which use a raised dimple at one end of a cell to make electrical contact with the next cylindrical cell, substantially planar cells need not have such raised dimple(s).

For many applications requiring high electrical power including HEVs and PHEVs, it is desirable that the battery delivers electrical power at a high voltage in order to reduce the required current needed to supply the electrical power which in turn will beneficially reduce the need for high-current carrying materials to the devices using the electrical power. Electrical power is the multiple of voltage and current and high voltage delivery of electrical power to a device, for example an electric motor, will require thinner or less conductive current carriers (for example copper wire) to the device which will reduce their cost. Electric vehicles for example may require a battery to provide electrical power at 300 to 600 volts. This high voltage is typically achieved by externally connecting multiple lower voltage battery modules electrically in series. This is in part due to safety considerations in assembling and operating a series connected “stack” of typical “pouch” cells within a battery module, since at higher voltages and especially above approximately 60 Volts, there is a significant risk of electrical arcing and a severe shock hazard since the edge peripheries of “flat” cells such as typical “pouch” cells have their cell terminals exposed. For safety these cell terminals are connected electrically in series within a low voltage battery module, for example, having less than 60 volts.

An object of the present invention is to provide improved short circuit resistance between positive and negative electrode plates in a cell module. Another alternate or additional object of the present invention is to improve the ease and/or reduce the cost and/or complexity of manufacturing or disassembly of a modular battery cell module. Another alternate or additional object of the present invention to improve the ease of scalability of manufacturing.

The cell modules of the present invention may be used in place of the cell modules disclosed in incorporated-by-reference U.S. Patent Publication No. 2009-0239130 A1, and may be having similar housings and contacts as the cell modules disclosed therein.

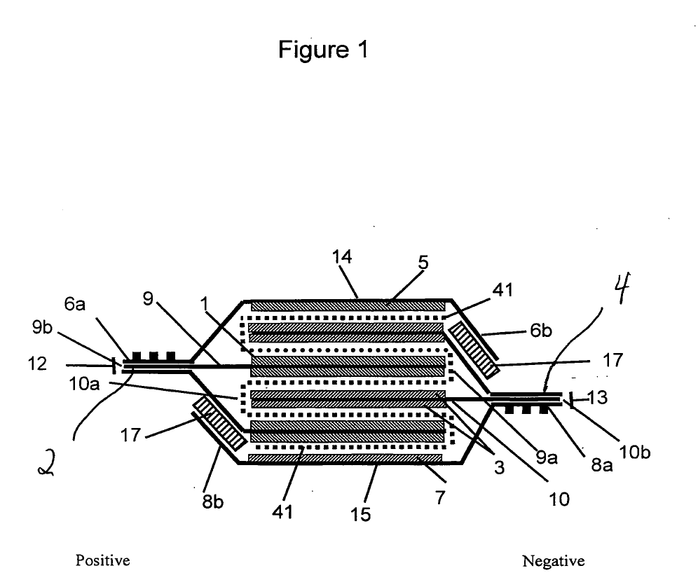

As illustrated in FIG. 1, a positive end-electrode plate 14 has two tabs 6a, 6b at either side (positive as shown) and the negative end-electrode plate 15 has two tabs 8a, 8b (negative as shown).

Between the end-electrode plates 14, 15 are positive electrodes plates 9 interleaved with negative electrodes plates 10. End plates 14, 15 have active material coatings 5, 7 respectively (shown in exaggerated fashion) on one side, while plates 9, 10 have active material coatings 1, 3 on both sides, respectively. Plates 9 have a first end 9b and a second end 9a, and plates 10 have a third end 10a and a fourth end 10b.

One of the tabs 6a of the positive end-electrode plate 14 is connected, preferably by welding, to the tabs 2 of the positive electrode plates 9 to form an end tab 12 which constitutes a positive terminal of the cell module 23. In similar fashion, one of the tabs 8a of the negative end-electrode plate 15 is connected, preferably by welding, to the tabs 4 of the negative electrode plates 10 to form an end tab 13 which constitutes a negative terminal of the cell module 23. In FIG. 1, the end-electrode plates 14 and 15 are shown coated on one side only while their other sides are uncoated and through the end tabs 12 and 13 respectively, their other sides present outer positive and negative cell-termination surfaces respectively for subsequent high voltage battery assembly, for example through the interconnectors disclosed in incorporated-by-reference U.S. Patent Publication No. 2009-0239130 A1.

In actual practice, the number of electrodes and separator length is varied and selected to achieve the required electrochemical energy storage capacity and the power required. The surface area thus also can be scaled. In addition to increasing the electrochemical energy storage, a larger number of electrodes will allow higher rates of charge and discharge for the same amount of energy. The larger surface area with multiple electrodes in the present invention lowers the specific electrochemical current density per unit electrode area within the cell module, i.e., the amperes per square centimeter of electrode is reduced for a larger number of electrodes so that the electrodes can deliver more total current at a lower current density with less loss in delivery voltage. In batteries, high electrode current density results in reduced battery voltage due to the well-known electrochemical principles of electrode polarization or voltage loss. A multiple of more than 30 electrode pairs, in practice, could typically be bonded with a welder, such as an ultrasonic metal welder, into welded end tabs 12 and 13 of the positive and negative electrodes, respectively. The electrode tabs are preferably connected along the full lengths thereof on opposite sides of the electrode cell module, as illustrated by the end tab 12 on the positive side of the cell module and the end tab 13 on the negative side. The outside top surface of the cell module presents the bare foil surface of the positive end-electrode 14 and the outside bottom surface presents the bare metal surface of the negative end-electrode 15. Voltage and temperature sensors attached to the individual tabs or to the electrode tabs provide early information related to safety due to their close proximity to the electrode active materials.

According to the present invention, and as shown in FIG. 1, interleaved between positive and negative electrode plates 9 and 10 is a continuous layer of separator 41. Due to the separator 41, which is made of an electrically-insulating material, possible short circuits at the second and third ends 9a, 10a respectively of the interior positive electrodes 9 and negative electrodes 10 respectively are reduced. The first and fourth ends of the positive and negative electrodes are the ends of the electrode tabs 2 and 4 respectively and are illustrated in FIGS. 1 as 9b and 10b respectively. A single piece of separator 41 of sufficient length is wrapped around the electrode ends in a serpentine manner as illustrated in FIG. 1 in cross section and subsequently sealed by the sealant and housed as per incorporated-by-reference U.S. Patent Publication No. 2009-0239130 A1. The separator 41 may be made for example of micro-porous polyolefin and be in sheet form.

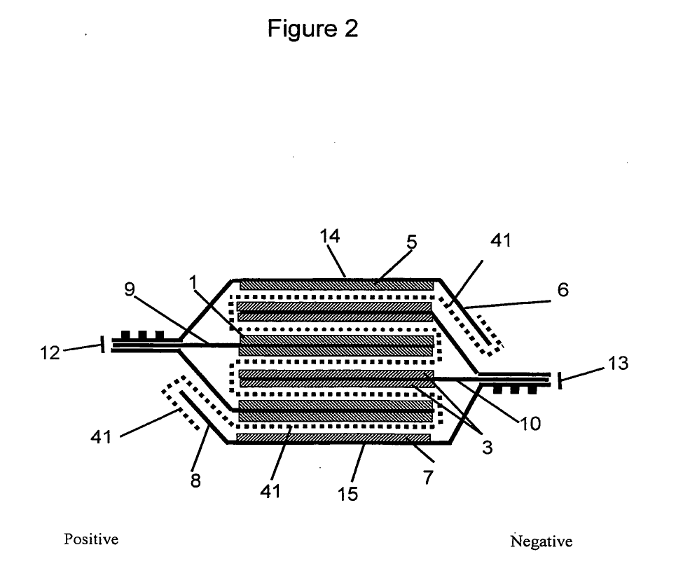

The separator may be applied as a continuous length on a roll. Electrodes can be aligned with the axes of their full-width tabs parallel to the axis of the roll. The width of the separator is wider than the width of the electrodes (by typically 5 mm on each side) to provide insulation between the edges of the electrodes (orthogonal to the ends of the electrodes). Electrodes are stacked alternately: cathode and anode, with the positive electrode tabs (first ends) on one side of the stack, and all the negative electrode tabs (fourth ends) on the opposite side of the stack. After each new electrode placement, the roll of separator is wrapped over the opposite non-tab end of the new electrode in the stack and traversed over the electrode in the direction of the new tab end as illustrated in FIGS. 1 and 2. As an example, after placement of a new negative electrode, the roll of separator is wrapped over the non-tab third end of the new negative electrode in the stack and traversed over the new negative electrode in the direction of the new fourth tab end of the new negative electrode, then after placement of a new positive electrode, the roll of separator is wrapped over the non-tab second end of the new positive electrode in the stack and traversed over the new positive electrode in the direction of the new first tab end of the new positive electrode and so on until multiple positive and negative electrodes are interleaved with the separator to form the stack of electrodes each wrapped with separator at their non-tab ends.

These layers of separator provide a mechanically stable and continuous layer of insulation, in an area at the second and third ends of the electrodes which can be vulnerable to electrical shorting in conventional stacked-electrode assemblies, which rely on overlap and alignment of the free edges of the separator. The wrapping of separator in the present invention remains mechanically stable during shock and vibration, whereas the free edges of the separator in conventional stacked-electrode assemblies are subject to movement which can lead to electrical shorting between adjacent positive and negative electrodes.

Projecting edges of the separator 41 outside of the electrode plates and orthogonal to the full lengths of the tabs 12 and 13 may be bonded together, while also allowing electrolyte entry, by for instance ultrasonic plastic welding, to mechanically stabilize the separator from lateral movement prior to sealing the projecting edges into the plastic frame of the housing—said frame function and disposition is disclosed in U.S. Patent Publication No. 2009-0239130 A1 and incorporated-by-reference herein. The arrangement shown in FIG. 1 may also be easier to assemble by automation in mass manufacturing.

An insulator 17 may be provided to insulate tabs 6b and 8a from tabs 4 and 2 respectively.

The separator 41 also may be extended beyond the terminating positions shown in FIG. 1 which, as illustrated in FIG. 2, thereby eliminates the need for an insulator 17 since the separator 41 is electronically insulating. The arrangement as illustrated in FIG. 2 may be advantageous in mass manufacturing. In FIG. 2, the separator 41 wraps around the ends of positive and negative tabs 6b and 8b respectively.

After the positive and negative electrode plates are stacked with the separator between the electrodes as described herein, electrolyte can be added to the stack. The electrolyte is uniformly spread throughout the space between the electrodes which contains the separator in order to provide necessary electrolyte for uniform charge and discharge of the positive and negative electrode plates. The separator is microporous and electrically insulating and after electrolyte filling also contains electrolyte within its pores. The distance between the electrodes can be minimized in order to minimize the electrolyte resistance and so uniformly filling the space between electrodes of a battery cell with electrolyte can be a slow process of electrolyte penetration of the space between the electrodes and the pores of the separator and non-uniformity of electrolyte penetration can lead to non-uniformity in coverage of the electrode surfaces with electrolyte which in turn leads to non-uniform electrode charge and discharge behavior. Pre-wetting of the microporous separator with the electrolyte before it is interleaved with the positive and negative electrode plates in the present invention can provide faster and more uniform electrolyte coverage of the electrode surfaces than electrolyte addition after the stack is built. As a preferred embodiment, the serpentine separator manner in which the separator is interleaved with electrodes in the present invention includes electrolyte addition to the separator prior to interleaving between electrodes, by immersing the separator in electrolyte prior to said interleaving with the electrodes, for example by passing the separator under a roller immersed in tank containing electrolyte. Alternatively, application of electrolyte could be achieved by spraying the separator with electrolyte or by other means prior to interleaving with the electrodes.

Once sealed and housed to form the cell module, the cell modules can be stacked and connected with interconnectors as described in incorporated-by-reference U.S. Patent Publication No. 2009-0239130 A1.

It will be appreciated by those ordinarily skilled in the art that obvious variations and changes can be made to the examples and embodiments described in the foregoing description without departing from the broad inventive concept thereof. It is understood, therefore, that this disclosure is not limited to the particular examples and embodiments disclosed, but is intended to cover all obvious modifications thereof which are within the scope and the spirit of the disclosure as defined by the appended claims.

What is claimed is:

1. A cell module for a modular battery comprising:
a plurality of positive electrode plates having positive connections extending from the positive electrode plates and having a first end and an opposite second end;
a plurality of negative electrode plate having negative connections extending from the negative electrode plates and having a third end and an opposite fourth end, the positive and negative electrode plates alternating and being stacked so that the first and third ends are on a same side of the cell module and the second and fourth ends are on an opposite side; and
a separator between the positive and negative electrode plates and covering the second end and the third end.

2. The cell module as recited in claim 1 wherein the separator is a sheet of polymeric material.

3. The cell module as recited in claim 2 wherein the sheet includes polyolefin.

4. The cell module as recited in claim 1 wherein positive tabs extend from the first end, and negative tabs extend from the fourth end, the positive tabs being connected to form a positive terminal, and the negative tabs being connected to form a negative terminal.

5. The cell module as recited in claim 1 further comprising a positive electrode end plate and a negative electrode end plate, the separator extending between the positive electrode end plate and one of the negative electrode plates, and between the negative electrode end plate and the one of the positive electrode plates.

6. The cell module as recited in claim 5 further comprising an insulator between tabs of the positive electrode end plate and one negative electrode plate.

7. The cell module as recited in claim 5 wherein the separator extends beyond one end of the positive electrode end plate and one negative electrode plate and curves around the one end of the positive electrode end plate.

8. A modular battery comprising a plurality of the cell modules as recited in claim 1.

9. The modular battery as recited in claim 9 further comprising interconnectors between the plurality of cell modules.

10. A method for forming a cell module for a modular battery comprising:
interleaving a single piece of separator between a plurality of positive electrode plates and a plurality of negative electrode plates.

11. The method as recited in claim 10 further comprising adding electrolyte to the separator.

12. The method as recited in claim 11 wherein the electrolyte is added during the interleaving.
